(19) United States
(12) Patent Application Publication
(10) Pub. No.: US 2013/0341407 A1
(43) Pub. Date: Dec. 26, 2013

(54) DETACHABLE PRINT MATERIAL AND METHOD OF USE THEREOF

(71) Applicant: Johann Young, Kuala Lumpur (MY)

(72) Inventor: Johann Young, Kuala Lumpur (MY)

(73) Assignee: NEXBIS SDN. BHD., Kuala Lumpur (MY)

(21) Appl. No.: 13/884,072

(22) PCT Filed: Feb. 29, 2012
(86) PCT No.: PCT/MY12/00038

§ 371 Date: May 8, 2013

(30) Foreign Application Priority Data
Mar. 16, 2011 (MY) PI2011001181

(51) Int. Cl. G06K 19/06; G06K 7/10

(52) U.S. Cl. CPC G06K 19/06037; G06K 7/10544
USPC 235/472.01; 235/494

(57) ABSTRACT

A detachable print material (100) for providing real-time information and a method (200) for using the detachable print material (100), comprising at least two detachable portions (110), said detachable portions (110) comprising at least a means for receiving at least a coded image (120), which consists of a serial code having a link to retrieve the real-time information from a remote server. This coded image (120) comprises a plurality of dots (130) scattered across said means for receiving said coded image (120). A pre-installed application on an image capturing means is designed to scan and decode the coded image into the serial code, establish a network connection to the remote server, and retrieve the real-time information from the said remote server.

### TECHNICAL FIELD

The present invention relates to a detachable print material for providing information and a method of use thereof.

### BACKGROUND OF INVENTION

Personal identification documents, such as birth certificates, identification cards, driver's licenses, passports, traveler's visas, etc. contain information relating to the identity of a person. Aside from identification documents, there exists also ticketing means, such as tickets for access to public or private events, transit means, and transport means or locations having the full information printed on it. These identification documents and ticketing means more often than not will have to be carried by the owner at all times. However, these identification documents and ticketing means can be easily misplaced, which will lead to the exposure of the information contained therein by anyone with access to the same. Also, the information leak will provide an opportunity for criminals to commit the act of identity fraud or create counterfeit copies of the ticketing means.

Currently, a variety of traveler's visas allows the visa information to be printed onto a sticker. This negates the hassle of printing directly into a passport. However, these methods require the visa sticker to be stuck onto the passport, hence the traveler must also carry the passport at all times throughout the traveling period.

Most travelers are reluctant to carry their passport at all times, as they worry that they may lose their passport. Once the traveler keeps the passport in a secured static location, this defeats the purpose of having a visa sticker with useful information on it. For example, during the course of inspection, the relevant enforcer would not be able to obtain the necessary information of the traveler, as the passport is not with the traveler. Even if the traveler is forced to carry his/her passport at all times, it is inconvenient for the traveler to carry such a document if they are engaging in certain activities, such as water sports and the like.

Whilst the visa sticker provides vital and sensitive information that is useful during the course of inspection, the risk of an information leak also increases as the details are laid out on the sticker and can be viewed by anyone.

In light of the above, there is a need to introduce a new product that is superior than the conventional product and is able to address all the aforesaid issues. Specifically, there is a need to introduce a new product that is able to provide the benefit of being substantially difficult to create counterfeit copies of the same, thereby protecting the privacy of the owner and preventing the owner from losing his/her identification documents. Further to that, there is also a need to introduce a new product that is able to prevent counterfeiting of the ticketing means.

### SUMMARY OF INVENTION

The object of the present invention is to provide a detachable print material, which comprises at least a coded image for providing real-time information.

Another object of the present invention is to provide a method to retrieve real-time information from a remote server through the detachable print material having a coded image.

In one embodiment of the present invention, the detachable print material comprises at least two detachable portions. Each portion has a means for receiving at least a coded image and this coded image further comprises a plurality of dots randomly scattered on a pre-defined area of the detachable portion, and the plurality of dots is associated to a specific information packet for providing real-time information.

In this embodiment, the specific information packet comprises a digital representation of a serial code, which is a link to retrieve real-time information that is stored in a remote server. The printed material can be used as an identification, information, or ticketing means for access to a public event, private event, transit means, transport means, or location. More particularly, the said printed material is able to provide at least the identity of a person.

In another embodiment of the present invention, the detachable print material comprises at least two detachable portions. Each portion has at least a coded image and the coded image further comprises a plurality of dots randomly scattered on a pre-defined area of the detachable portion, and the plurality of dots is associated to a specific information packet for providing real-time information. The plurality of dots is a digital representation of a serial code having a link to retrieve real-time information that is stored in a remote server.

In yet another embodiment of the present invention, the method of producing the detachable print material comprises the steps of:
a. compiling real-time information;
b. storing said real-time information into a remote server, said real-time information comprising at least the identity of a person;
c. assigning at least a serial code to the real-time information;
d. encoding said serial code into at least a coded image;
e. transmitting said coded image to at least a printing means; and
f. imprinting said coded image onto at least a portion of the detachable print material.

In this method, the serial code is encoded into a specific information packet represented by a plurality of dots, and said printing means can be any kind of printing machine, such as a computer printer, a network printer, a ticket generator, a photocopy machine, or the like.

In still another embodiment of the present invention, the method of using the detachable print material comprises the steps of:
a. capturing a picture of the coded image using an image capturing means;
b. decoding the coded image into the digital representation of a serial code;
c. transmitting the serial code from the image capturing means to a remote server;
d. retrieving real-time information associated to the serial code from the remote server;
e. transmitting the retrieved real-time information from the remote server to the image capturing means; and
f. displaying the retrieved real-time information to the user.

In this method, the image capturing means can be any kind of electronic device having a camera, such as a mobile phone, a smart phone, a personal digital assistant, a scanner, a tablet PC, a laptop with a webcam, a personal computer with a webcam, or the like.

### BRIEF DESCRIPTION OF DRAWINGS

FIG. 1 is an illustration of a detachable print material for providing real-time information in accordance with the present invention;

FIG. 2 is a flow diagram illustrating a method of producing the detachable print material as shown in FIG. 1 in accordance with the present invention; and

FIG. 3 is a flow diagram illustrating a method of using the detachable print material as shown in FIG. 1 in accordance with the present invention.

### DETAILED DESCRIPTION OF THE PREFERRED EMBODIMENTS

Described below are preferred embodiments of the present invention with reference to the accompanying drawings. Each of the following preferred embodiments describes an example in which the system and method improves over existing prior art.

The image capturing means described below is refering to any type of device that is capable of capturing images, more specifically, to devices having a camera. This image capturing means includes mobile phones, smart phones, personal digital assistants, tablet PCs, personal computers with a webcam, and the like. The details of the said image capturing means will not be further explained in this specification, as it is common knowledge for a person having ordinary skill in the art of computer engineering.

The configuration of the invention is not limited to the modules mentioned in the following description.

In one embodiment, the present invention discloses a detachable print material (100) for providing real-time information. The real-time information is to be retrieved by using any scanning means or image capturing means, and the said real-time information is stored in a remotely located server. Each of the real-time information is assigned with a specific serial code, and the serial code is encoded into a coded image (120). The coded image (120) is then printed on the detachable print material (100). An image capturing means is used to capture the coded image (120), which then proceed to decode the coded image (120) into the serial code using an application pre-installed in the image capturing means. The image capturing means then transmits the serial code over a wired or wireless network to the remote server where the real-time information to be retrieved is stored. The remote server then processes the serial code and retrieves the real-time information associated with this serial code. The remote server then returns the retrieved real-time information to the requesting image capturing means, which then displays the real-time information to a user.

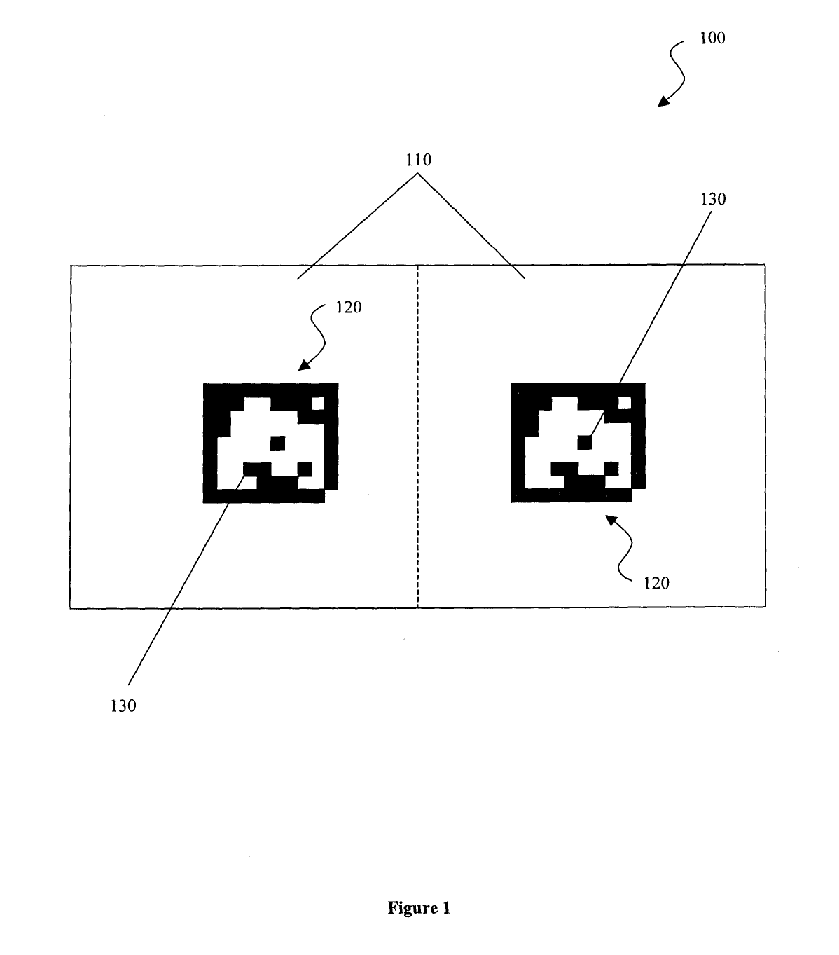

Referring to FIG. 1, a detachable print material (100) for providing real-time information is disclosed. This detachable print material (100) comprises at least two detachable portions (110) and is configured to receive at least a coded image (120). The said coded image (120) comprises a plurality of dots (130) randomly scattered on a pre-defined area of the detachable portion (110), and the plurality of dots (130) is associated to a specific information packet, which comprises a digital representation of a serial code for providing real-time information. This serial code is decodable by using a pre-installed application in an image capturing means and it contains a link to retrieve the real-time information, which is stored in a remote server.

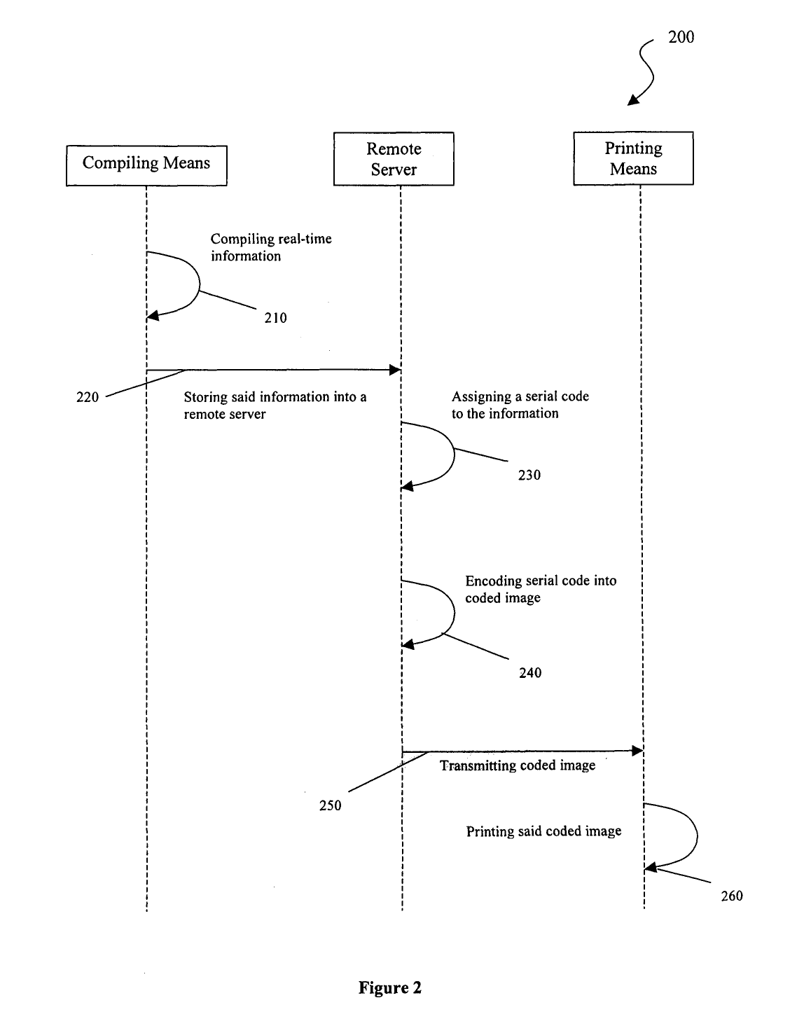

FIG. 2 shows a method (200) of producing the detachable print material (100) that is able to provide real-time information. This method starts off with compiling specific information (210) in which said specific information comprises at least the identity of a person.

The said compiled specific information is then stored into a remote server (220), which will then assign at least a serial code to the information (230).

The said remote server then encodes said serial code into at least a coded image (240) in which said serial code is encoded into a specific information packet represented by a plurality of dots (130).

Subsequently, said remote server transmits said coded image to at least a printing means (250), and said printing means imprints said coded image onto at least a detachable portion (110) of the detachable print material (100) (260).

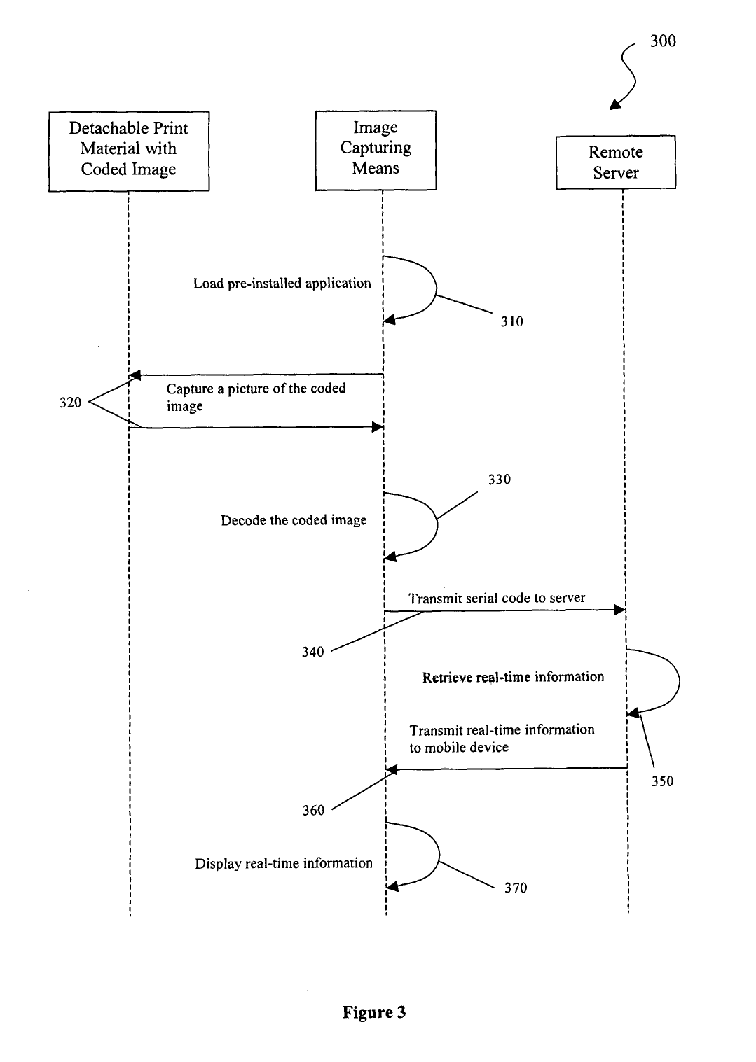

FIG. 3 shows a method (300) of retrieving real-time information from a remote server by using the detachable print material (100). This method starts off with loading a pre-installed application in an image capturing means (310) in which the said image capturing means can be a mobile phone, a smart phone, a personal digital assistant, a tablet PC, a laptop with a webcam, or a personal computer with a webcam.

The pre-installed application of the image capturing means then captures a picture of the coded image (320).

Subsequently, the pre-installed application decodes the coded image into a specific information packet (330), which is a digital representation of a serial code.

The image capturing means then establishes a network connection for connecting to a remote server and transmits the serial code from the image capturing means to the remote server (340).

Subsequently, the remote server processes the serial code and retrieves the real-time information associated with this serial code (350), and the remote server transmits the retrieved real-time information to the requesting image capturing means (360), which then displays the real-time information to a user (370).

The detachable print material (100) as hereinbefore described is suitable to be used as an identification means, information means, or ticketing means for access to a public event, private event, transit means, transport means, or location. This detachable print material (100) is preferably made from water-resistant and abrasion-resistant materials in which these materials can be a paper, a sticker, or a card. Below are some of the possible ways to use the detachable print material (100) and is described in the following examples by using the said material (100) as a movie ticket and a traveler's visa.

### Example 1

The detachable print material (100) of the present invention is used as a ticket for entering a movie theater. In this case, the detachable print material (100) can be made from paper with the coded image (120), which is printed on both the detachable portions (110) during the sales of ticket. The coded image contains information such as the movie time, duration of the movie, title of the movie, the relevant viewing cinema or hall, etc. A cinema attendant retrieves such information from the detachable portions by using a reader to scan the coded image, where the said reader is linked via network to a remote server containing such information.

### Example 2

The detachable print material (100) of the present invention is used as an identification means for identifying the identity of a traveler. In this case, the detachable print material (100) can be made from paper, sticker, card, or any combination thereof. A coded image is imprinted on both the detachable portions, which contains the visa information of the traveler that is stored in a remote server. One of the detachable portions (110) is for attachment onto a passport, and another detachable portion (110) is to be carried by the traveler, and thus the traveler is not required to carry his/her passport at all times during the traveling period. When necessary, the identity of the traveler can be easily retrieved, checked and verified by an enforcer, for example an officer from the immigration department. The enforcer only has to employ an image capturing means with a pre-installed application to scan and decode the coded image (120), and retrieves the identity of the traveler from the remote server.

A summary then of what has been hereinbefore described by way of example of the present invention is a detachable print material (100) for providing real-time information and a method (200) for using said detachable print material (100) comprising at least two detachable portions (110), said detachable portions (110) comprising at least a means for receiving at least a coded image (120), said means having positioned in a pre-defined area of said detachable portions (110), wherein the coded image (120) has a plurality of dots (130) randomly scattered on said means for receiving said coded image (120) and the plurality of dots (130) is associated to a specific information packet. The specific information packet further comprises a digital representation of a serial code, which contains a link to retrieve the real-time information that is stored in a remote server.

In as much as the present invention is subject to many variations, modifications and changes in detail, it is intended that all matter contained in the foregoing description or shown in the accompanying drawings shall be interpreted as illustrative and not in a limiting sense.

1. A detachable print material (100), comprising:
at least two detachable portions (110);
said detachable portions (110) comprising at least a means for receiving at least a coded image (120);
wherein said coded image (120) comprises:
a plurality of dots (130) randomly scattered on said means for receiving said coded image (120); and
said plurality of dots (130) is associated to a specific information packet for providing real-time information.

2. The detachable print material (100) in accordance with claim 1, wherein said means for receiving said coded image is positioned in a pre-defined area of said detachable portions (110).

3. The detachable print material (100) in accordance with claim 1, wherein the information packet further comprises a digital representation of a serial code.

4. The detachable print material (100) in accordance with claim 3, wherein the serial code further comprises a link to retrieve the real-time information, which is stored in a remote server.

5. A detachable print material (100), comprising:
at least two detachable portions (110);
said detachable portions (110) comprising at least a means for receiving at least a coded image (120);
said means is positioned in a pre-defined area of said detachable portions (110);
wherein said coded image (120), comprising:
a plurality of dots (130) randomly scattered on said means for receiving said coded image (120); and
said plurality of dots (130) is associated to a specific information packet for providing real-time information in which said plurality of dots (130) is a digital representation of a serial code having a link to retrieve real-time information that is stored in a remote server.

6. The detachable print material (100) in accordance with any one of claims 1 and 5, wherein the detachable print material (100) is a paper, a sticker, or a card.

7. The detachable print material (100) in accordance with any one of claims 1 and 5, wherein the detachable potions (110) are made from water-resistant material.

8. The detachable print material (100) in accordance with any one of claims 1 and 5, wherein the detachable portions (110) are made from abrasion-resistant material.

9. The detachable print material (100) in accordance with any one of claims 1 and 5, wherein the detachable print material (100) is any one or more of an identification, information or ticketing means for accessing any one or more of an event, transit means, transport means or location.

10. The detachable print material (100) in accordance with any one of claims 1 and 5, wherein the detachable print material (100) is an identification means for identifying the identity of a person.

11. The detachable print material (100) in accordance with any one of claims 1, 4, and 5, wherein said real-time information comprises at least the identity of a person.

12. The detachable print material (100) in accordance with any one of claims 1, 5, and 10, wherein one of the detachable portions (110) of the identification means is for attaching onto a passport.

13. The detachable print material (100) in accordance with any one of claims 1, 5, and 10, wherein one of the detachable portions (110) of the identification means is for the purpose of being carried by or on a person.

14. A method (200) of producing a detachable print material containing specific information(100), comprising:
compiling specific information (210);
storing said information into a remote server (220);
assigning at least a serial code (230) to the information;
encoding said serial code into at least a coded image (240);
transmitting said coded image to at least a printing means (250);
imprinting said coded image onto the detachable print material (260); and
wherein said information is real-time information.

15. The method (200) of producing the detachable print material containing specific information (100) in accordance with claim 14, wherein said real-time information comprises at least the identity of a person.

16. The method (200) of producing the detachable print material containing specific information (100) in accordance with claim 14, wherein said serial code is encoded into a specific information packet represented by a plurality of dots.

17. The method (200) of producing the detachable print material (100) in accordance with claim 14, wherein said printing means comprises a computer printer, a network printer, a ticket generator, or a printing machine.

18. A method (300) of using the detachable print material (100) as claimed in any one of claims 1 and 5, comprising:
capturing a picture of the coded image using an application in an image capturing means (310, 320);
decoding the coded image into the serial code (330);
transmitting the serial code from the image capturing means to a remote server (340);
retrieving the real-time information associated to the serial code from the remote server (350);
transmitting the retrieved real-time information from the remote server to the image capturing means (360); and
displaying said retrieved real-time information on the image capturing means (370).

19. The method (300) of using the detachable print material (100) in accordance with claim 18, wherein the image capturing means comprises a mobile phone, a smart phone, a personal digital assistant, a tablet PC, scanner, a laptop with webcam, or a personal computer with webcam.

20. The method (300) of using the detachable print material (100) in accordance with claim 18, wherein the real-time information comprises at least the identity of a person.
